(19) United States
(12) Patent Application Publication
(10) Pub. No.: US 2026/0149543 A1
(43) Pub. Date: May 28, 2026

(54) POSITIONING REFERENCE SIGNAL CONFIGURATION METHOD, COMMUNICATION SYSTEM, AND RELATED APPARATUS

(71) Applicant: HUAWEI TECHNOLOGIES CO., LTD., Shenzhen (CN)

(72) Inventors: Xin Gao, Beijing (CN); Mengting Liu, Beijing (CN); Cheng Li, Shanghai (CN)

(21) Appl. No.: 19/355,131

(22) Filed: Oct. 10, 2025

Related U.S. Application Data
(63) Continuation of application No. PCT/CN2024/083671, filed on Mar. 25, 2024.

(30) Foreign Application Priority Data
Apr. 13, 2023 (CN) 202310431146.0

(51) Int. Cl. H04L 5/00; H04W 72/25

(52) U.S. Cl. CPC H04L 5/0051; H04W 72/25

(57) ABSTRACT

This application discloses a positioning reference signal configuration method, a communication system, and a related apparatus. In the method, an SL-PRS and data may be sent in a same slot based on a specified time-frequency mapping manner. The time-frequency mapping manner describes a time-frequency position of the SL-PRS relative to a DMRS in the data in the same slot, and the DMRS is a reference signal in a PSSCH. In this way, a device that sends the SL-PRS can configure a time-frequency position of the SL-PRS in advance, and sends the SL-PRS on the configured time-frequency position, thereby avoiding a collision between the SL-PRS and the DMRS in the PSSC.

### CROSS-REFERENCE TO RELATED APPLICATIONS

This application is a continuation of International Application No. PCT/CN2024/083671, filed on Mar. 25, 2024, which claims priority to Chinese Patent Application No. 202310431146.0, filed on Apr. 13, 2023. The disclosures of the aforementioned applications are hereby incorporated by reference in their entireties . . .

### BACKGROUND

During the evolution of a latest 3rd generation partnership project (3GPP) R18 standard, a sidelink (Sidelink) positioning manner is mentioned in the evolution of a next-generation positioning technology. During the evolution of the current 3GPP R18 standard, for the sidelink positioning manner, a new positioning reference signal, namely, a sidelink positioning reference signal (SL-PRS), is defined to implement a positioning function.

### SUMMARY

At least one embodiment provides a positioning reference signal configuration method, a communication system, and a related apparatus, so that a time-frequency position of an SL-PRS is specified, and a device can send and receive the SL-PRS on the specified time-frequency position, thereby avoiding a collision between the SL-PRS and a demodulation reference signal (DMRS) in a physical sidelink shared channel (PSSCH).

According to a first aspect, an embodiment provides a positioning reference signal configuration method. The method may be applied to a first device, or may be applied to a chip in the first device, or may be applied to a logical module or software that can implement all or some functions of the first device. The following uses the first device as an example for description. The positioning reference signal configuration method includes: sending a first SL-PRS and first data in a same slot based on a first time-frequency mapping manner, where the first time-frequency mapping manner describes a time-frequency position of the first SL-PRS relative to a first demodulation reference signal DMRS in the first data in the same slot, and the first DMRS is a reference signal in a PSSCH.

According to the method provided in the first aspect, an SL-PRS and data may be sent in a same slot based on a fixed time-frequency mapping manner. In this way, a device that sends the SL-PRS may configure a time-frequency position of the SL-PRS in advance, and sends the SL-PRS on the configured time-frequency position, thereby avoiding a collision between the SL-PRS and the DMRS in the PSSCH, and avoiding an impact of a position of the SL-PRS in the slot on data demodulation performance.

With reference to the first aspect, in at least one embodiment, the first SL-PRS and the first data are sent based on configuration information of an SL-PRS. The configuration information includes the number of symbols and a comb size. The first time-frequency mapping manner is determined based on the configuration information, where the number of symbols for the first SL-PRS in one slot is the number of symbols in the configuration information, and a comb size of the first SL-PRS in frequency domain is the comb size in the configuration information.

Before the SL-PRS is sent, the number of symbols and a comb size of the SL-PRS may be learned from the configuration information of the SL-PRS.

With reference to the first aspect, in at least one embodiment, the configuration information further includes: an initial symbol location and an initial subcarrier location of the SL-PRS. The initial symbol location is a start symbol location of a second SL-PRS in response to a second SL-PRS being sent, the initial subcarrier location is a start subcarrier location of the second SL-PRS, and a slot in which the second SL-PRS is located does not include data.

The configuration information may further include a default initial symbol location and a default initial subcarrier location, so that in response to the SL-PRS being separately sent in a slot, the SL-PRS can be sent based on the default initial symbol location and the default initial subcarrier location. In addition, this reduces a process of notifying two devices, that respectively send and receive the SL-PRS, of a symbol location and a subcarrier location before the two devices send and receive the SL-PRS.

With reference to the first aspect, in at least one embodiment, the configuration information included in a first device is information pre-configured in advance in the first device or information sent by a base station.

In other words, the configuration information may be information pre-configured in advance in a device, or may be information sent by a network device, for example, a base station.

With reference to the first aspect, in at least one embodiment, the first time-frequency mapping manner is further determined based on a first start symbol location and a first start subcarrier location, where the first start symbol location is different from the initial symbol location, and the first start subcarrier location is different from the initial subcarrier location. Before sending the first SL-PRS and the first data in the same slot, the method further includes: sending the first start symbol location and the first start subcarrier location, where a start symbol location of the first SL-PRS is the first start symbol location, and a start subcarrier location of the first SL-PRS is the first start subcarrier location.

In other words, to cause both the sender device and the receiver device to send and receive the SL-PRS on an agreed time-frequency position, the device that sends the SL-PRS may notify a start symbol location and a start subcarrier location of the SL-PRS in advance before sending the SL-PRS, so that the device that receives the SL-PRS can learn of the time-frequency position of the SL-PRS in advance based on the configuration information, the start symbol location, and the start subcarrier location, to ensure that a receiver device can accurately receive the SL-PRS.

According to a second aspect, at least one embodiment provides a positioning reference signal configuration method. The method may be applied to a second device, or may be applied to a chip in the second device, or may be applied to a logical module or software that can implement all or some functions of the second device. The following uses the second device as an example for description. The positioning reference signal configuration method includes: receiving a first SL-PRS and first data in a same slot based on a first time-frequency mapping manner, where the first time-frequency mapping manner describes a time-frequency position of the first SL-PRS relative to a first DMRS in the first data in the same slot, and the first DMRS is a reference signal in a PSSCH.

According to the method provided in the second aspect, an SL-PRS and data may be received in a same slot based on a fixed time-frequency mapping manner. In this way, a device that receives the SL-PRS may learn of a time-frequency position of the SL-PRS in advance, and receive the SL-PRS on the known time-frequency position, to accurately receive the SL-PRS, thereby ensuring positioning accuracy of positioning performed by the receiver device using the SL-PRS and performance of channel estimation performed by the receiver device using a DMRS. With reference to the second aspect, in at least one embodiment, the first SL-PRS and

the first data are received based on configuration information of an SL-PRS. The configuration information includes the number of symbols and a comb size. The first time-frequency mapping manner is determined based on the configuration information, where the number of symbols for the first SL-PRS in one slot is the number of symbols in the configuration information, and a comb size of the first SL-PRS in frequency domain is the comb size in the configuration information.

Before the SL-PRS is received, the number of symbols and a comb size of the SL-PRS may be learned from the configuration information of the SL-PRS.

With reference to the second aspect, in at least one embodiment, the configuration information further includes an initial symbol location and an initial subcarrier location of the SL-PRS. The initial symbol location is a start symbol location of a second SL-PRS in response to the second SL-PRS being received, the initial subcarrier location is a start subcarrier location of the second SL-PRS, and a slot in which the second SL-PRS is located does not include data.

The configuration information may further include a default initial symbol location and a default initial subcarrier location. In this way, in response to knowing that the slot in which the SL-PRS is located not including data, the device that receives the SL-PRS may directly learn of the time-frequency position of the SL-PRS based on the default initial symbol location and the default initial subcarrier location, so that this reduces a process of notifying two devices, that respectively send and receive the SL-PRS, of a symbol location and a subcarrier location before the two devices send and receive the SL-PRS.

With reference to the second aspect, in at least one embodiment, the configuration information included in a second device is information pre-configured in advance in the second device or information sent by a first device or a base station.

In other words, the configuration information may be information pre-configured in advance in a device, or may be information sent by a network device, for example, a base station, or by another terminal device.

With reference to the second aspect, in at least one embodiment, the first time-frequency mapping manner is further determined based on a first start symbol location and a first start subcarrier location, where the first start symbol location is different from the initial symbol location, and the first start subcarrier location is different from the initial subcarrier location. Before receiving the first SL-PRS and the first data in the same slot, the method further includes: receiving the first start symbol location and the first start subcarrier location, where a start symbol location of the first SL-PRS is the first start symbol location, and a start subcarrier location of the first SL-PRS is the first start subcarrier location.

In other words, to cause both the sender device and the receiver device to send and receive the SL-PRS on an agreed time-frequency position, the device that receives the SL-PRS may learn of a start symbol location and a start subcarrier location of the SL-PRS in advance before receiving the SL-PRS, so that the device that receives the SL-PRS can learn of the time-frequency position of the SL-PRS in advance based on the configuration information, the start symbol location, and the start subcarrier location, to ensure that the receiver device can accurately receive the SL-PRS.

With reference to the second aspect, in at least one embodiment, the method further includes: determining, based on the first SL-PRS, location information of a device that sends the first SL-PRS, where the location information includes one or more of the following: a distance, an angle, and an altitude.

The device that receives the SL-PRS may use the SL-PRS to position the device.

With reference to the first aspect and the second aspect, in at least one embodiment, the first time-frequency mapping manner is further determined according to a rule for determining a symbol location of an SL-PRS. The rule for determining the symbol location includes: in a same slot, M symbols for the SL-PRS are at M symbol locations just before the last symbol for a DMRS in the PSSCH, or M symbols for the SL-PRS are at M symbol locations including and just before the last symbol in the PSSCH, where the M symbol locations do not include a symbol location of the DMRS in the PSSCH, and M is the number of symbols for the SL-PRS.

The symbol location of the SL-PRS may be determined according to a preset rule, and both the sender device and the receiver device may determine the symbol location of the SL-PRS based on the symbol location of the DMRS in the PSSCH in the same slot and the preset rule. In this way, the sender device and the receiver device can obtain the time-frequency position of the SL-PRS through calculation, and can send and receive the SL-PRS on an agreed same time-frequency position, so that this reduces a process in which the sender device notifies the receiver device of the symbol location of the SL-PRS in advance, thereby reducing signaling overheads.

With reference to the first aspect and the second aspect, in at least one embodiment, the first time-frequency mapping manner is further determined based on mapping relationships, for different numbers of symbols, between the symbol location of the SL-PRS and the total number of symbols in a slot, the number of symbols for the DMRS in the PSSCH, and the number of symbols occupied by a physical sidelink control channel PSCCH.

A symbol location of the first SL-PRS in a slot is determined based on a mapping relationship, for the number of symbols for the first SL-PRS, with the total number of symbols in the slot in which the first SL-PRS is located, the number of symbols for the DMRS in the PSSCH, and the number of symbols occupied by the PSCCH.

The symbol location of the SL-PRS may also be determined based on an association relationship between the SL-PRS and a related parameter of other data in a same slot. In this way, the sender device and the receiver device can obtain the time-frequency position of the SL-PRS through calculation, and can send and receive the SL-PRS on an agreed same time-frequency position, so that this reduces a process in which the sender device notifies the receiver device of the symbol location of the SL-PRS in advance, thereby reducing signaling overheads.

With reference to the first aspect and the second aspect, in at least one embodiment, the first time-frequency mapping manner is further determined according to a rule for determining a start subcarrier location of a start symbol for the SL-PRS. The rule for determining the start subcarrier location includes: the start subcarrier location of the start symbol for the SL-PRS is determined by a value obtained by performing a modulo operation on a comb size of the SL-PRS based on a cyclic redundancy check (CRC), and a start subcarrier location of the first SL-PRS in a slot is determined based on a value obtained by performing a modulo operation on a comb size of the first SL-PRS based on a first CRC, where the first CRC is a cyclic redundancy check of sidelink control information SCI.

A start subcarrier location of the SL-PRS may be determined according to a preset rule, and both the sender device and the receiver device may obtain the start subcarrier location of the SL-PRS through calculation according to the preset rule, so that this reduces a process in which the sender device notifies the receiver device of the start subcarrier location of the SL-PRS in advance, thereby reducing signaling overheads.

According to a third aspect, at least one embodiment provides a communication apparatus, where the apparatus includes a module or unit configured to implement the method described in the first aspect, the second aspect, any one of the implementations according to the first aspect, and any one of the implementations according to the second aspect.

According to a fourth aspect, at least one embodiment provides a communication apparatus, including a processor, where the processor is coupled to a memory, and the memory is configured to store a program or instructions. In response to the program or the instructions being executed by the processor, the apparatus is enabled to perform the method described in the first aspect, the second aspect, any one of the implementations of the first aspect, and any one of the implementations of the second aspect.

According to a fifth aspect, at least one embodiment provides an electronic device, including a memory, one or more processors, and one or more programs. In response to the one or more processors executing the one or more programs, the electronic device is enabled to implement the method described in the first aspect, the second aspect, any one of the implementations of the first aspect, and any one of the implementations of the second aspect.

According to a sixth aspect, at least one embodiment provides a computer-readable storage medium, including instructions. In response to the instructions being run on an electronic device, the electronic device is enabled to perform the method described in the first aspect, the second aspect, any one of the implementations of the first aspect, and any one of the implementations of the second aspect.

According to a seventh aspect, at least one embodiment provides a computer program product. In response to the computer program product running on a computer, the computer is enabled to perform the method described in the first aspect, the second aspect, any one of the implementations of the first aspect, and any one of the implementations of the second aspect.

### BRIEF DESCRIPTION OF DRAWINGS

FIG. 1 shows communication systems according to at least one embodiment;

FIG. 2 is a schematic flowchart of a positioning reference signal configuration method according to at least one embodiment;

FIG. 3 shows a slot structure in a sidelink communication process according to at least one embodiment:

FIG. 4 is a schematic flowchart of another reference signal configuration method according to at least one embodiment:

FIG. 5 is a diagram of a location of an SL-PRS in a slot according to a rule for determining a symbol location according to at least one embodiment:

FIG. 6 is a diagram of a location of an SL-PRS in a slot according to a rule for determining a symbol location according to at least one embodiment:

FIG. 7 is a diagram of a symbol location of an SL-PRS in a slot according to at least one embodiment; and

FIG. 8 and FIG. 9 are diagrams of structures of communication apparatuses according to embodiments of this application.

### DESCRIPTION OF EMBODIMENTS

The following describes technical solutions in at least one embodiment clearly and in detail with reference to the accompanying drawings.

During the evolution of a current 3GPP R18 standard, that an SL-PRS may be sent together with data is defined. However, currently, how to configure a time-frequency position of the SL-PRS is still not summarized.

In response to the SL-PRS being sent together with other data, a time-frequency position of the SL-PRS may affect data demodulation performance. Further, in response to there being no clear indication or anti-collision mechanism, the SL-PRS is likely to collide with a demodulation reference signal (Demodulation Reference Signal, DMRS) in a physical sidelink shared channel (Physical sidelink shared channel, PSSCH), affecting positioning accuracy of positioning using the SL-PRS, and affecting channel estimation performance for the DMRS.

Therefore, how to configure the time-frequency position of an SL-PRS is an urgent problem to be resolved currently.

At least one embodiment provides a positioning reference signal configuration method. The method relates to sending a first SL-PRS and first data in a same slot based on a first time-frequency mapping manner. Correspondingly, the first SL-PRS and the first data may be received in the same slot based on the first time-frequency mapping manner. The first time-frequency mapping manner describes a time-frequency position of the first SL-PRS relative to a first DMRS in the first data in the same slot, where the first DMRS is a reference signal in the PSSCH.

The method specifies a time-frequency position of an SL-PRS relative to a DMRS in data, sent together with the SL-PRS, in response to a device sending or receiving the SL-PRS, so that the device that sends the SL-PRS can allocate a time-frequency position of the SL-PRS in advance, and sending the SL-PRS on the specified time-frequency position. Meanwhile, the device that receives the SL-PRS can obtain the time-frequency position of the SL-PRS in advance, and accurately receive the SL-PRS on the specified time-frequency position. In addition, according to the method, a collision between the SL-PRS and the DMRS in the PSSCH is further avoided, and positioning accuracy of positioning using the SL-PRS and performance of channel estimation using the DMRS are ensured.

The first time-frequency mapping manner may be determined based on configuration information of the SL-PRS, a specific parameter of or a rule for determining or a mapping table for a symbol location of the SL-PRS, and a specific parameter of or a rule for determining a start subcarrier location of the SL-PRS. The configuration information of the SL-PRS may include: the number of symbols, a comb size, and the like of the SL-PRS. For specific descriptions of the configuration information, the symbol location or the start subcarrier location of the SL-PRS, the determining rule, and the mapping table, refer to subsequent content. Details are not described herein.

First, to better understand the positioning reference signal configuration method disclosed in at least one embodiment, a communication system to which at least one embodiment is applicable is described.

Technical solutions in at least one embodiment may be applied to various communication systems, for example, a global system for mobile communication, a long term evolution (long term evolution, LTE) system, a universal mobile telecommunications system, a 4th generation (4th generation, 4G) mobile communication technology system, a next-generation radio access network (next-generation radio access network, NG-RAN), a new radio (new radio, NR) technology system, or a 5th generation mobile communication technology (5G) system. In addition, with the continuous development of communication technologies, the technical solutions in at least one embodiment may be further applied to a subsequent evolved communication system, for example, a 6th generation mobile communication technology (6G) system or a 7th generation mobile communication technology (7G) system.

The communication system provided in at least one embodiment may involve no network device, one or more network devices, and a plurality of terminal devices. Both uplink transmission and downlink transmission may be performed between the network device and the terminal device. In addition, the communication system may further include a channel for data/signal transmission between the network device and the terminal device, for example, a transmission medium like an optical fiber, a cable, or an atmosphere.

In at least one embodiment, the network device may be a device having a wireless transceiver function, or may be a chip disposed on the device having the wireless transceiver function. The network device includes but is not limited to: an evolved NodeB (evolved NodeB, eNB), a radio network controller (radio network controller, RNC), a NodeB (NodeB, NB), a base station controller (base station controller, BSC), a base station transceiver station (base transceiver station, BTS), a home network device (for example, a home evolved NodeB or home NodeB, HNB), a baseband unit (baseband unit, BBU), an access node (access point, AP) in a wireless fidelity (wireless fidelity, Wi-Fi) system, a wireless relay node, a wireless backhaul node, a transmission point (transmission and reception point, TRP or transmission point, TP), or the like. The network device may alternatively be a device used in a 4G, 5G, or even 6G system, for example, an evolved NodeB (NodeB, eNB, or e-NodeB, evolutional NodeB) in LTE, a next-generation LTE base station (next-generation eNodeB, ng-eNB), a next-generation base station (next-generation NodeB, gNodeB, or gNB), a transceiver point, or a transmission point (TRP or TP). The network device may alternatively be a network node that forms a gNB or a transmission point, for example, a baseband unit (BBU), a distributed unit (distributed unit, DU), a picocell (Picocell) network device, a femtocell (Femtocell) network device, or a road side unit (road side unit, RSU) in an intelligent driving scenario. The base station may be a macro base station, a micro base station, a picocell base station, a small cell, a relay station, a balloon station, or the like. Alternatively, the network device may be a server, a wearable device, a vehicle-mounted device, or the like. All or some functions of the network device in at least one embodiment may alternatively be implemented by using a function of software that is run on hardware, or may be implemented by using a virtualization function that is instantiated on a platform (for example, a cloud platform).

In at least one embodiment, the terminal device may also be referred to as user equipment (user equipment, UE), a terminal, an access terminal, a subscriber unit, a subscriber station, a mobile station, a remote station, a remote terminal, a mobile device, a user terminal, a user agent, or a user apparatus, and may be used in a 4G system, a 5G system, a 6G system, or the like. The terminal device in at least one embodiment may be a joint device that performs digital signal transmission and receiving on an ordinary telephone line, or may be a mobile phone (mobile phone), a tablet computer (Pad), a computer having a wireless transceiver function, a head mounted display (head mounted display, HMD), a VR terminal device (for example, VR glasses), an augmented reality (augmented reality, AR) terminal device (for example, AR glasses), a mixed reality (mixed reality, MR) terminal device, a wireless terminal in industrial control (industrial control), a haptic terminal device, a vehicle-mounted terminal device, a wireless terminal in self-driving (self-driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), an RSU of a type of a foregoing wireless terminal, a wearable terminal device, or the like.

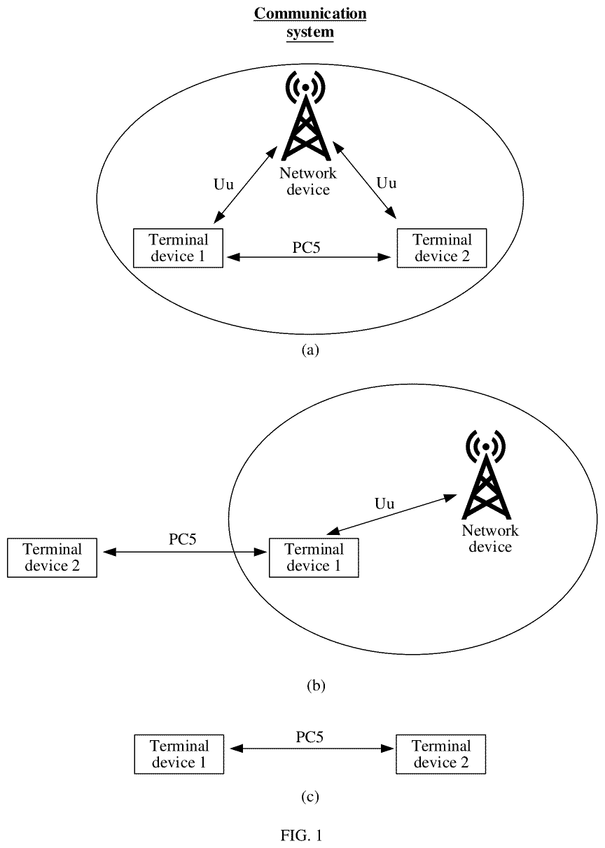

FIG. 1 shows communication systems according to at least one embodiment. (a), (b), and (c) in FIG. 1 are respective diagrams of communication systems according to at least one embodiment.

The communication system shown in (a) in FIG. 1 is described by using one network device and two terminal devices (namely, a terminal device 1 and a terminal device 2 shown in (a) in FIG. 1) as an example. In (a) in FIG. 1, a base station is used as an example of the network device and a mobile phone is used as an example of the terminal device.

In the communication system shown in (a) in FIG. 1, the terminal device 1 and the terminal device 2 are located within a communication coverage area of the network device, and both the terminal device 1 and the terminal device 2 may communicate with the network device. For example, the terminal device 1 (or the terminal device 2) and the network device may communicate with each other through a Uu interface. The Uu interface is a cellular network communication interface. In other words, communication between the terminal device 1 (or the terminal device 2) and the network device may be performed through an uplink or a downlink, and may be reliable communication with a long distance and a larger range. The terminal device 1 and the terminal device 2 may communicate with each other through a PC5 interface. The PC5 interface is a direct-connection communication interface. In other words, the terminal device 1 and the terminal device 2 may communicate with each other through a sidelink.

In at least one embodiment, with reference to the communication system shown in (a) in FIG. 1, in an example, the terminal device 1 and the terminal device 2 may obtain configuration information that is of an SL-PRS and that is sent by the network device, and the terminal device 1 may send, to the terminal device 2 based on a specified time-frequency mapping manner, information including the SL-PRS and data. Correspondingly, the terminal device 2 may receive, based on the same time-frequency mapping manner, the information sent by the terminal device 1.

As shown in (b) in FIG. 1, the communication system may include a network device, a terminal device 1, and a terminal device 2. For specific descriptions of the network device and the terminal device, refer to the foregoing descriptions of the network device and the terminal device. Details are not described herein again.

In the communication system shown in (b) in FIG. 1, the terminal device 1 is located within a communication coverage area of the network device, and the terminal device 2 is located outside the communication range of the network device. In other words, the terminal device 1 may communicate with the network device, and the terminal device 2 cannot communicate with the network device. For example, the terminal device 1 and the network device may communicate with each other through a Uu interface, and the terminal device 1 and the terminal device 2 may communicate with each other through a PC5 interface. For specific descriptions of the Uu interface and the PC5 interface, refer to related content described in (a) in FIG. 1. Details are not described herein again.

In at least one embodiment, with reference to the communication system shown in (b) in FIG. 1, in an example, the terminal device 1 may obtain configuration information that is of an SL-PRS and that is sent by the network device, the terminal device 1 may send the configuration information of the SL-PRS to the terminal device 2, and the terminal device 1 may send, to the terminal device 2 based on a specified time-frequency mapping manner, information including the SL-PRS and data. Correspondingly, the terminal device 2 may receive, based on the same time-frequency mapping manner, the information sent by the terminal device 1.

As shown in (c) in FIG. 1, the communication system may include a terminal device 1 and a terminal device 2. For specific descriptions of the terminal device, refer to the foregoing descriptions of the terminal device. Details are not described herein again.

In the communication system shown in (c) in FIG. 1, the terminal device 1 and the terminal device 2 are located outside a communication coverage area of the network device, and the terminal device 1 and the terminal device 2 may communicate with each other through a PC5 interface. For specific descriptions of the PC5 interface, refer to related content described in (a) in FIG. 1. Details are not described herein again.

In at least one embodiment, with reference to the communication system shown in (c) in FIG. 1, in an example, the terminal device 1 may send configuration information of an SL-PRS to the terminal device 2, and the terminal device 1 may send, to the terminal device 2 based on a specified time-frequency mapping manner, information including the SL-PRS and data. Correspondingly, the terminal device 2 may receive, based on the same time-frequency mapping manner, the information sent by the terminal device 1.

In at least one embodiment, the terminal device 1 may alternatively be a first device, and the terminal device 2 may alternatively be a second device.

The communication system may further include more or fewer devices. For example, the communication system may further include a location management function (Location management function, LMF), a road side unit (Road side unit, RSU), and the like. This is not limited in at least one embodiment.

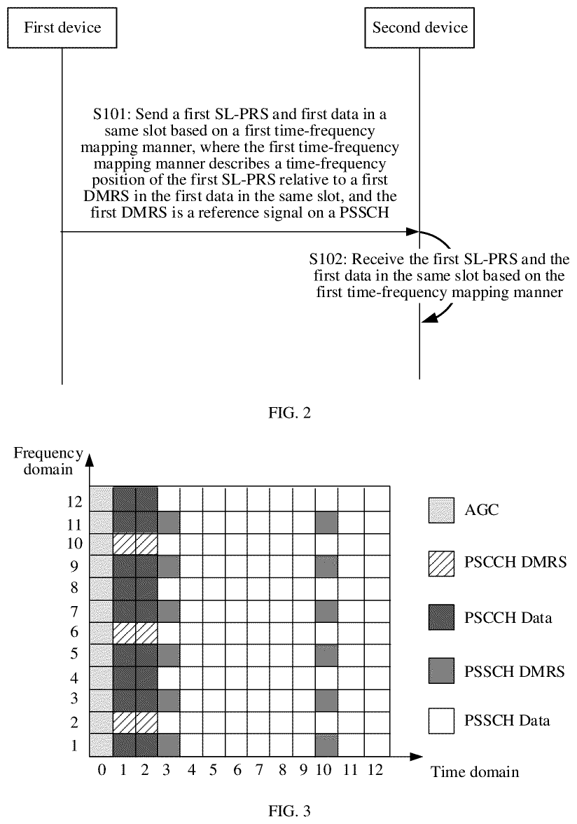

FIG. 2 is a schematic flowchart of a positioning reference signal configuration method according to at least one embodiment.

As shown in FIG. 2, the positioning reference signal configuration method may include the following steps.

S101: A first device sends a first SL-PRS and first data to a second device in a same slot based on a first time-frequency mapping manner, where the first time-frequency mapping manner describes a time-frequency position of the first SL-PRS relative to a first DMRS in the first data in the same slot, and the first DMRS is a reference signal in a PSSCH.

A communication connection is established between the first device and the second device.

For example, a sidelink communication connection may be established between the first device and the second device, and may also be referred to as a device-to-device (device-to-device, D2D) communication connection.

The first device or the second device may be used as an initiator to initiate a request for establishing the sidelink communication connection.

The following uses an example in which the first device is used as an initiator, to roughly describe, in the following two cases, a process in which the communication connection is established between the first device and the second device.

Case 1: In response to a base station being used as a network device, the base station manages and controls the process in which the communication connection is established between the first device and the second device.

Specifically, the first device may send a request signal to the base station, where the request signal is used for requesting to pair with a nearby device that supports sidelink communication. After receiving the request signal, the base station may send a pairing signal to a device that is near the first device and that supports the sidelink communication, where the pairing signal includes an identifier of the first device. After receiving the pairing signal, the second device may establish the sidelink communication connection to the first device.

Case 2: In response to no network device being involved, the first device and the second device autonomously complete establishment of the communication connection.

Specifically, the first device may send, to the outside, a request signal including an identifier of the first device, where the request signal is used for requesting to pair with a nearby device that supports sidelink communication. After receiving the request signal, the second device may return a response to the first device, to establish the sidelink communication connection to the first device.

Case 1 is applicable to the terminal devices 1 and the terminal devices 2 in the communication systems shown in (a) and (b) in FIG. 1, and Case 2 is applicable to the terminal device 1 and the terminal device 2 in the communication system shown in (c) in FIG. 1.

A slot is a unit of a time-frequency resource, and includes J consecutive orthogonal frequency division multiplexing (Orthogonal Frequency Division Multiplexing, OFDM) symbols in time domain, where J is a natural number greater than zero. For example, FIG. 3 shows an example of a slot structure in a sidelink communication process.

As shown in FIG. 3, in the slot structure, locations of different signals in a same slot in time domain and frequency domain are described by using time domain as a horizontal coordinate and frequency domain as a vertical coordinate. From a perspective of the horizontal coordinate, one spacing represents one symbol interval, and from a perspective of the vertical coordinate, one spacing represents one subcarrier spacing.

From FIG. 3, the slot includes eight symbols, and one symbol includes 12 subcarriers. The eight symbols include symbols in automatic gain control (Automatic gain control, AGC), in a PSSCH, and in a physical sidelink control channel (Physical sidelink control channel, PSCCH). Each of the PSSCH and the PSCCH includes data (Data) and a demodulation reference signal (DMRS). A symbol location for the AGC in the slot structure is “0”, symbol locations of a signal in the PSCCH in the slot structure include “1” and “2”, and symbol locations of a signal in the PSSCH in the slot structure include “3”, “4”, “5”, “6”, “7”, “8”, “9”, “10”, “11”, and “12”.

The relative time-frequency position includes a relative time domain position and/or a relative frequency domain position. The first time-frequency mapping manner describes locations of the first SL-PRS relative to the DMRS in the PSSCH in time domain and frequency domain in the same slot. In this way, in response to a time-frequency position of the DMRS in the PSSCH being known, a time-frequency position of the first SL-PRS may be determined based on the time-frequency position of the DMRS, so that the first device can clearly indicate the time-frequency position of the first SL-PRS, send the first SL-PRS on the time-frequency position of the first SL-PRS, to determine the locations of the first SL-PRS relative to the DMRS in the PSSCH in time domain and in frequency domain, so as to avoid a collision between the first SL-PRS and the DMRS in the PSSCH.

S102: The second device receives, in the same slot based on the first time-frequency mapping manner, the first SL-PRS and the first data that are sent by the first device.

The second device receives the first SL-PRS and the first data by using a time-frequency mapping manner that is the same as the time-frequency mapping manner used in response to the first device sending the first SL-PRS and the first data.

In this way, the second device can accurately receive the first SL-PRS in response to the time-frequency position of the first SL-PRS being known. In addition, the locations of the first SL-PRS relative to the DMRS in the PSSCH in time domain and in frequency domain are used to avoid an impact of the first SL-PRS in the DMRS in response to the second device receiving the DMRS in the PSSCH. This ensures performance of channel estimation performed by the second device using the DMRS.

Further, in at least one embodiment, after obtaining the first SL-PRS, the second device may determine location information of the first device based on the first SL-PRS, where the location information may include one or more of the following: a distance, an angle, an altitude, and the like. The second device may estimate an actual geographical location of the first device based on the location information of the first device. The distance may be a distance from the first device to the second device, the angle may be a relative angle between the first device and the second device, and the altitude may be a relative altitude between the first device and the second device.

In addition, in actual application, in response to the second device estimating the actual geographical location of the first device, in addition to receiving the first SL-PRS sent by the first device and determining the location information of the first device based on the first SL-PRS, the second device may also receive location information that is of the first device and that is determined by another terminal device, for example, a third device or a fourth device. The location information determined by the third device may be location information that is of the first device and that is determined, after the third device receives an SL-PRS sent by the first device, based on the SL-PRS by the third device, and the location information determined by the fourth device may be location information that is of the first device and that is determined, after the fourth device receives an SL-PRS sent by the first device, based on the SL-PRS by the fourth device.

In other words, in addition to sending the SL-PRS to the second device, the first device further sends an SL-PRS to another device, for example, the third device or the fourth device, to help position the first device.

For example, the actual geographical location of the first device may be estimated according to the following formula:

$$\sqrt{{( {x}_{1} - {x}_{U E} )}^{2} + {( {y}_{1} - {y}_{U E} )}^{2}} - \sqrt{{( {x}_{2} - {x}_{U E} )}^{2} + {( {y}_{2} - {y}_{U E} )}^{2}} = c * Δ {t}_{21} \sqrt{{( {x}_{1} - {x}_{U E} )}^{2} + {( {y}_{1} - {y}_{U E} )}^{2}} - \sqrt{{( {x}_{3} - {x}_{U E} )}^{2} + {( {y}_{3} - {y}_{U E} )}^{2}} = c * Δ {t}_{31} \qquad Formula 1$$

(xᵢ, yᵢ), where i=1, 2, and 3, represents a known location of an i^{th} terminal device, which may be a location of the second device, the third device, or the fourth device. (x_{UE}, y_{UE}) represents a location of a to-be-positioned target, which may be the location of the first device. Δt₂₁ represents a time difference between arrival time t₂ that is of an SL-PRS and that is obtained by the third device through measurement and arrival time t₁ that is of an SL-PRS and that is obtained by the second device through measurement, Δt₃₁ represents a time difference between arrival time t₃ that is of an SL-PRS and that is obtained by the fourth device through measurement and the arrival time t₃ that is of the SL-PRS and that is obtained by the second device through measurement, and c is a speed of light.

In Formula 1, an optimal solution of the formula may be estimated by using an optimization algorithm like a least square algorithm or a particle swarm filtering algorithm, to calculate the actual geographical location of the first device.

From step S101 and step S102, only in response to the first time-frequency mapping manner being known, the first device or the second device can use the first time-frequency mapping manner to send or receive the first SL-PRS and the first data. The following describes in detail manners of determining the first time-frequency mapping manner.

The following provides three manners of determining the first time-frequency mapping manner.

Manner 1: Before an SL-PRS is sent, a time-frequency position of the SL-PRS is notified in advance.

In this manner, the first time-frequency mapping manner may be determined based on configuration information of the SL-PRS, a first start symbol location, and a first start subcarrier location.

The configuration information of the SL-PRS may include: the number of symbols and a comb size. The number of symbols is the number of symbols occupied by the SL-PRS in one slot, and the comb size is a comb size of the SL-PRS in frequency domain.

In response to the first device sending the first SL-PRS and the first data, the first device may send the first SL-PRS and the first data based on the configuration information of the SL-PRS. In this way, in response to the first device sending the first SL-PRS, the number of symbols for the first SL-PRS in one slot is the number of symbols in the configuration information, and a comb size of the first SL-PRS in frequency domain is the comb size in the configuration information.

In the first device, the configuration information may be information pre-configured in advance in the first device, or may be information sent by a base station.

Correspondingly, in response to receiving the first SL-PRS and the first data, the second device may receive the first SL-PRS and the first data based on the configuration information of the SL-PRS. In this way, in response to the second device receiving the first SL-PRS, the number of symbols for the first SL-PRS in one slot is the number of symbols in the configuration information, and a comb size of the first SL-PRS in frequency domain is the comb size in the configuration information.

In the second device, the configuration information may be information pre-configured in advance in the second device, or may be information sent by a base station or the first device.

The configuration information of the SL-PRS is configuration information for an SL-PRS in a shared resource pool. A resource pool may be understood as a group of pre-configured time-frequency resources. All terminal devices that use the resource pool to send and receive data may use same configuration information. The shared resource pool includes time-frequency resources of the SL-PRS and data. The time-frequency resources of the SL-PRS and the data in the shared resource pool are allocated, so that all terminal devices that use the shared resource pool in a communication system can send and receive the SL-PRS and the data based on same time-frequency allocation.

In addition, a start symbol location of the first SL-PRS is the first start symbol location, and a start subcarrier location of the first SL-PRS is the first start subcarrier location.

Before sending the first SL-PRS and the first data, the first device may first configure the time-frequency domain position of the first SL-PRS, and send the start symbol location and the start subcarrier location of the first SL-PRS to the second device in advance. In this way, before receiving the first SL-PRS and the first data, the second device may determine the time-frequency position of the first SL-PRS in advance based on the configuration information of the SL-PRS and the start symbol location and the start subcarrier location of the first SL-PRS, to accurately receive the first SL-PRS during reception of the first SL-PRS.

Information that is about the time-frequency position of the first SL-PRS and that is sent by the first device to the second device may be the first start symbol location and the first start subcarrier location, or may alternatively be a location of each symbol and a location of each occupied subcarrier of the first SL-PRS. The information that is about the time-frequency position of the first SL-PRS and that is sent by the first device to the second device is within the protection scope of embodiments described herein provided that the information can be used to determine the time-frequency position of the first SL-PRS, and the information that is of the time-frequency position of the first SL-PRS and that is sent by the first device to the second device is not limited in at least one embodiment.

In at least one embodiment, the first device may send the start symbol location and the start subcarrier location of the first SL-PRS by sending the following sidelink control information (Sidelink control information, SCI) indication information to the second device:
SCI format 2-X:

Symbol offset-“X” bits using to indicate the symbol offset of the SL-PRS, where X is determined by the Time resource assignment.

RE Offset—“N_comb” bits using to indicate the RE offset of the first symbol of SL-PRS, where N_comb is the comb size of SL-PRS configured by higher layer parameter combSize.

Symbol offset represents the start symbol location of the first SL-PRS, and RE Offset represents a start subcarrier location of a start symbol for the first SL-PRS on a frequency-domain subcarrier.

In at least one embodiment, the configuration information of the SL-PRS may further include: an initial symbol location and an initial subcarrier location of the SL-PRS. The initial symbol location and the initial subcarrier location are default locations of the SL-PRS, and the default locations are represented as the following: In response to the SL-PRS being separately sent in a slot, the initial symbol location may be directly used as a start symbol location of the SL-PRS in the slot, and the initial subcarrier location is used as a start subcarrier location of the SL-PRS. In this way, the first device does not need to additionally send the start symbol location and the start subcarrier location of the SL-PRS to the second device, and does not need to consider whether the SL-PRS collides with the DMRS in the PSSCH. The first device and the second device may directly learn of the time-frequency position of the SL-PRS based on the configuration information, thereby reducing a complicated interaction procedure between the first device and the second device. In addition, the initial symbol location and the initial subcarrier location are the default locations of the SL-PRS, so that the device that receives the SL-PRS or a device that is performing resource selection can also learn of the time-frequency position of the SL-PRS without any underlying signaling indication, so as to determine a position for detecting the SL-PRS.

For example, the first device may send a second SL-PRS to the second device, where a slot in which the second SL-PRS is located does not include data. In this case, a start symbol location of the second SL-PRS in the slot is the initial symbol location in the configuration information, and a start subcarrier location of the second SL-PRS in the slot is the initial subcarrier location in the configuration information.

In response to the configuration information of the SL-PRS including the initial symbol location and the initial subcarrier location of the SL-PRS, the second device uses the initial symbol location and the initial subcarrier location as a start symbol location and a start subcarrier location of the SL-PRS in a slot by default. In response to the second device receiving the start symbol location, namely, the first start symbol location, and the start subcarrier location, namely, the first start subcarrier location, that are additionally sent by the first device, the second device replaces the default initial symbol location and the default initial subcarrier location with the first start symbol location and the first start subcarrier location.

In at least one embodiment, the first start symbol location is different from the initial symbol location, and the first start subcarrier location is different from the initial subcarrier location.

The configuration information of the SL-PRS may further include other content. This is not limited in at least one embodiment.

In at least one embodiment, the configuration information of the SL-PRS may be configured as the following signaling:

SL-ResourcePool-r16 ::= SEQUENCE {
...
SL-PRS-Config-r18 ::= SEQUENCE {
...
numOfSymb INTEGER {1,2,4,6}
combSize INTEGER {1,2,4,6,...}
DefalutSymbOffset INTEGER {0,1,2,3,4,5,6,...}
DefalutREOffset INTEGER {0,1,2,3,4,5,6,...}
...
}
}

In the foregoing signaling, “numOfSymb” represents the number of symbols, “combSize” represents a comb size, “DefalutSymbOffset” represents an initial symbol location, and “DefalutREOffset” represents an initial subcarrier location.

From Manner 1, for the time-frequency position of the SL-PRS, both devices may agree on the number of symbols and the comb size in advance, and before sending data, a sender device may notify a receiver device of the start symbol location and the start subcarrier location of the SL-PRS, so that the sender device and the receiver device can respectively send and receive the SL-PRS based on a same time-frequency mapping manner. In addition, different devices may agree on different frequency-domain subcarrier locations, to implement frequency division multiplexing for the SL-PRS and increase a multiplexing capability.

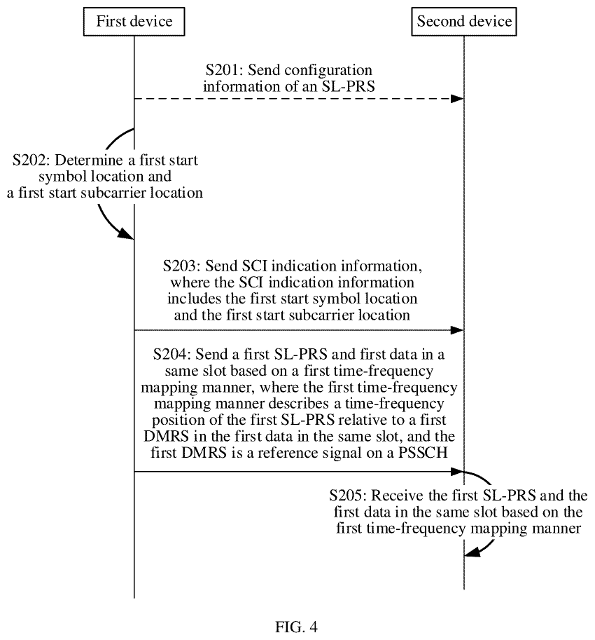

For ease of understanding Manner 1, the following describes in detail, with reference to FIG. 4, an interaction procedure between the sender device and the receiver device in Manner 1.

FIG. 4 is a schematic flowchart of another reference signal configuration method according to at least one embodiment.

As shown in FIG. 4, the reference signal configuration method may include the following steps.

S201: A first device sends configuration information of an SL-PRS to a second device.

The first device may send the configuration information of the SL-PRS to the second device after establishing a communication connection to the second device. For specific descriptions of the configuration information, refer to the foregoing content. Details are not described herein again.

In addition, in response to the first device having previously established a communication connection to the second device and sent the configuration information of the SL-PRS to the second device, the first device does not need to repeatedly send the configuration information in response to establishing a communication connection again. Alternatively, in response to the first device changing the configuration information, the first device may resend changed configuration information.

Step S201 is an optional step, and the configuration information of the SL-PRS may be pre-configured in a device in a device development phase. In this case, the first device does not need to send the configuration information to the second device, and the configuration information is pre-configured in advance in the first device and the second device.

In addition, in at least one embodiment, a third-party device (base station) may be further included, and the base station may send the configuration information of the SL-PRS to the first device and/or the second device.

S202: The first device determines a first start symbol location and a first start subcarrier location.

The first start symbol location and the first start subcarrier location may be a start symbol location and a start subcarrier location that are of the SL-PRS and that are configured by the first device to avoid a collision between the SL-PRS and a DMRS in a PSSCH that is sent together with the SL-PRS.

S203: The first device sends SCI indication information to the second device, where the SCI indication information includes the first start symbol location and the first start subcarrier location.

Correspondingly, the second device receives the SCI indication information that includes the first start symbol location and the first start subcarrier location.

S204: The first device sends a first SL-PRS and first data to the second device in a same slot based on a first time-frequency mapping manner, where the first time-frequency mapping manner describes a time-frequency position of the first SL-PRS relative to a first DMRS in the first data in the same slot, and the first DMRS is a reference signal in the PSSCH.

The first time-frequency mapping manner is determined based on the configuration information of the SL-PRS, the first start symbol location, and the first start subcarrier location, and the first time-frequency mapping manner may indicate a symbol location of the first SL-PRS in a slot and a subcarrier location of the first SL-PRS in frequency domain.

S205: The second device receives, in the same slot based on the first time-frequency mapping manner, the first SL-PRS and the first data that are sent by the first device.

For specific content that is not described in detail in steps S201 to S205, refer to content in the foregoing steps S101 and S102. Details are not described herein again.

Manner 2: The sender device and the receiver device determine the time-frequency position of the SL-PRS according to a preset rule.

In this manner, the first time-frequency mapping manner may be determined based on the configuration information of the SL-PRS, a rule for determining a symbol location of the SL-PRS, and a rule for determining a start subcarrier location of a start symbol for the SL-PRS.

The configuration information of the SL-PRS may include: the number of symbols and a comb size, and may further include: an initial symbol location and an initial subcarrier location. For details about the configuration information of the SL-PRS, refer to the related descriptions in the foregoing Manner 1. Details are not described herein again.

The rule for determining the symbol location of the SL-PRS is used to determine a symbol location of the SL-PRS in a slot.

For example, assuming that the number of symbols for the SL-PRS is M, the rule for determining the symbol location may be any one of the following:

(1) In a same slot, M symbols for the SL-PRS are at M symbol locations just before the last symbol for the DMRS in the PSSCH, and the M symbol locations do not include a symbol location of the DMRS in the PSSCH.

Specifically, during determining of the symbol location of the SL-PRS, a symbol location occupied by the PSSCH may be first found in a slot, and then a symbol location of the last DMRS is found in the symbol location occupied by the PSSCH. Then, the M symbols for the SL-PRS are mapped to the M symbol locations just before the symbol location of the last DMRS, and in a mapping process, mapping starts from a symbol location just before the symbol location of the last DMRS. In response to there being another DMRS in the PSSCH, a symbol location of the DMRS is skipped and mapping is performed to a previous symbol location, until mapping of the M symbols is completed.

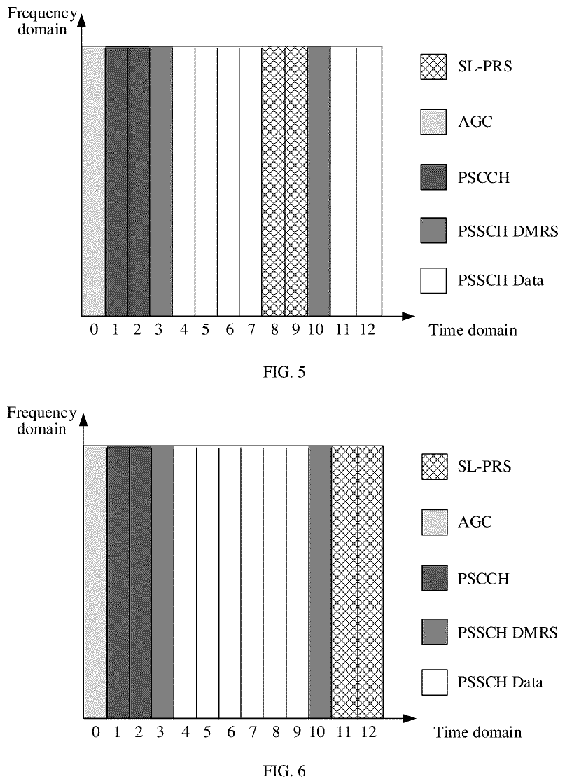

For example, FIG. 5 is a diagram of a location of an SL-PRS in a slot according to a rule for determining a symbol location according to at least one embodiment.

As shown in FIG. 5, M is 2. Symbol locations occupied by a PSSCH are “3”, “4”, “5”, “6”, “7”, “8”, “9”, “10”, “11”, and “12”, symbol locations of DMRSs in the PSSCH are “3” and “10”, and the symbol location of the last DMRS in the PSSCH is “10”. In this case, symbol locations of two symbols for the SL-PRS are respectively “8” and “9”.

FIG. 5 is merely an example, and does not constitute a limitation on embodiments described herein.

(2) In a same slot, M symbols for the SL-PRS are at M symbol locations including and just before the last symbol in the PSSCH, and the M symbol locations do not include a symbol location of the DMRS in the PSSCH.

Specifically, during determining of the symbol location of the SL-PRS, a symbol location occupied by the PSSCH may be first found in a slot, then the last symbol location is found in the symbol location occupied by the PSSCH. Then, forward mapping of the M symbols for the SL-PRS is performed from the last symbol location. In addition, in a mapping process, in response to there being the symbol location of the DMRS in the PSSCH, the symbol location is skipped and mapping is performed to a previous symbol location, until mapping of the M symbols is completed.

For example, FIG. 6 is a diagram of a location of an SL-PRS in a slot according to a rule for determining a symbol location according to at least one embodiment.

As shown in FIG. 6, M is 2. Symbol locations occupied by a PSSCH are “3”, “4”, “5”, “6”, “7”, “8”, “9”, “10”, “11”, and “12”, and the last symbol location occupied by the PSSCH is “12”. In this case, symbol locations of two symbols for the SL-PRS are respectively “11” and “12”.

FIG. 6 is merely an example, and does not constitute a limitation on embodiments of this application.

In response to the symbol location of the first SL-PRS being determined according to the rule for determining the symbol location of the SL-PRS, the number of symbols for the first SL-PRS may be obtained based on the configuration information of the SL-PRS.

From the rule for determining the symbol location that, the symbol location of the SL-PRS is determined according to the determining rule based on the symbol location of the DMRS in the PSSCH, thereby avoiding a collision between the SL-PRS and the DMRS in a slot. In addition, the symbol location of the SL-PRS is at an end of the slot, and a symbol occupied by the PSCCH is close to a front end of the slot, so that the determining rule further avoids a collision between the SL-PRS and a signal in the PSCCH.

The rule for determining the start subcarrier location of the start symbol for the SL-PRS is used to determine a start subcarrier location of the start symbol for the SL-PRS on a frequency-domain subcarrier.

For example, the rule for determining the start subcarrier location includes the following Formula 2:

$$R {E}_{offset} = ( {N}_{ID}^{X} ) mod N \qquad Formula 2$$

RE_{offset} represents a start subcarrier location value or offset value of the start symbol for the SL-PRS in frequency domain,

$${N}_{ID}^{X}$$

is a decimal of a cyclic redundancy check (Cyclic Redundancy Code, CRC), and N represents a comb size of the SL-PRS.

From Formula 2, the start subcarrier location of the start symbol for the SL-PRS is determined based on a value obtained by performing a modulo operation on the comb size of the SL-PRS based on the CRC.

In response to the start subcarrier location of the start symbol for the first SL-PRS being determined according to the rule for determining the start subcarrier location of the start symbol for the SL-PRS, a comb size of the first SL-PRS may be obtained based on the configuration information of the SL-PRS, where the CRC may be a first CRC, and the first CRC is a cyclic redundancy check in SCI. The SCI may be first-stage SCI in the PSCCH, or may be second-stage SCI in the PSSCH. The SCI may be located in the first data sent by the first device to the second device, or may be located in data previously sent by the first device to the second device. This is not limited in at least one embodiment.

In at least one embodiment, the rule for determining the symbol location of the SL-PRS and the rule for determining the start subcarrier location of the start symbol for the SL-PRS may be pre-configured in the first device and the second device, or may be specified in a protocol of communication between the first device and the second device. This is not limited in at least one embodiment.

From Manner 2 that, for the time-frequency position of the SL-PRS, both devices may agree on the number of symbols, the comb size, and the preset rule in advance, so that the sender device and the receiver device can respectively send and receive the SL-PRS based on a same time-frequency mapping manner. In addition, compared with Manner 1, there is no need to notify the start symbol location and the start subcarrier location of the SL-PRS in advance before the SL-PRS is sent, thereby reducing signaling overheads.

In Manner 2, an interaction procedure between the sender device and the receiver device may include S201, S204, and S205 in the interaction procedure shown in FIG. 4. Details are not described herein again.

Manner 3: The sender device and the receiver device determine the time-frequency position of the SL-PRS based on a pre-configured mapping relationship.

In this manner, the first time-frequency mapping manner may be determined based on the configuration information of the SL-PRS, a mapping table for a symbol location of the SL-PRS, and the rule for determining the start subcarrier location of the start symbol for the SL-PRS.

The configuration information of the SL-PRS may include: the number of symbols and a comb size, and may further include: an initial symbol location and an initial subcarrier location. For details about the configuration information of the SL-PRS, refer to the related descriptions in the foregoing Manner 1. Details are not described herein again.

The mapping table for the symbol location of the SL-PRS is used to determine the symbol location of the SL-PRS. The mapping table for the symbol location of the SL-PRS describes mapping relationships, for different numbers of symbols for the SL-PRS, between the symbol location of the SL-PRS and the total number of symbols in a slot, the number of symbols for the DMRS in the PSSCH, and the number of symbols occupied by the PSCCH. The total number of symbols is a sum of the number of symbols for the AGC, the number of symbols occupied by the PSSCH, and the number of symbols occupied by the PSCCH.

For example, the following lists Table 1 to Table 3 as examples to respectively describe symbol locations of the SL-PRS in a slot for different numbers of symbols for the SL-PRS.

TABLE 1
The number of symbols for an SL-PRS is 1

| | Symbol location of the SL-PRS | | | | | |
|---|---|---|---|---|---|---|
| | PSCCH occupying two symbols | | | PSCCH occupying three symbols | | |
| | Number of symbols for a DMRS | | | Number of symbols for the DMRS | | |
| Total number | in a PSSCH | | | in the PSSCH | | |
| of symbols | 2 | 3 | 4 | 2 | 3 | 4 |
| 6 | 3 | | | 3 | | |
| 7 | 3 | | | 3 | | |
| 8 | 3 | | | 3 | | |
| 9 | 6 | 5 | | 6 | 6 | |
| 10 | 6 | 5 | | 6 | 6 | |
| 11 | 7 | 7 | 9 | 7 | 7 | 9 |
| 12 | 7 | 7 | 9 | 7 | 7 | 9 |
| 13 | 7 | 9 | 9 | 7 | 9 | 9 |

TABLE 2
The number of symbols for an SL-PRS is 2

| | Symbol locations of the SL-PRS | | | | | |
|---|---|---|---|---|---|---|
| | PSCCH occupying two symbols | | | PSCCH occupying three symbols | | |
| | Number of symbols for a DMRS | | | Number of symbols for the DMRS | | |
| Total number | in a PSSCH | | | in the PSSCH | | |
| of symbols | 2 | 3 | 4 | 2 | 3 | 4 |
| 6 | 3, 4 | | | 3, 4 | | |
| 7 | 3, 4 | | | 3, 4 | | |
| 8 | 3, 4 | | | 3, 4 | | |
| 9 | 5, 6 | 5, 6 | | 6, 7 | 5, 6 | |
| 10 | 5, 6 | 5, 6 | | 6, 7 | 5, 6 | |
| 11 | 6, 7 | 7, 8 | 8, 9 | 7, 8 | 7, 8 | 8, 9 |
| 12 | 6, 7 | 7, 8 | 8, 9 | 7, 8 | 7, 8 | 8, 9 |
| 13 | 6, 7 | 8, 9 | 8, 9 | 7, 8 | 8, 9 | 8, 9 |

TABLE 3
The number of symbols for an SL-PRS is 4

| | Symbol locations of the SL-PRS | | | | | |
|---|---|---|---|---|---|---|
| | PSCCH occupying two symbols | | | PSCCH occupying three symbols | | |
| | Number of symbols for a DMRS | | | Number of symbols for the DMRS | | |
| Total number | in a PSSCH | | | in the PSSCH | | |
| of symbols | 2 | 3 | 4 | 2 | 3 | 4 |

| | | | | |
|---|---|---|---|---|
| 6 | | | | |
| 7 | | | | |
| 8 | | | | |
| 9 | 4, 5, 6, 7 | | | |
| 10 | 4, 5, 6, 7 | | | |
| 11 | 5, 6, 7, 8 | | 6, 7, 8, 9 | |
| 12 | 5, 6, 7, 8 | | 6, 7, 8, 9 | |
| 13 | 5, 6, 7, 8 | 7, 8, 9, 10 | 6, 7, 8, 9 | 7, 8, 9, 10 |

Table 1 to Table 3 show distribution of symbol locations of the SL-PRS in response to numbers of symbols for the SL-PRS being 1, 2, and 4 respectively, where the symbol location of the SL-PRS is related to the total number of symbols, the number of symbols for the DMRS in the PSSCH, and the number of symbols occupied by the PSCCH. The number of symbols for the SL-PRS, the total number of symbols in a slot, the number of symbols for the DMRS in the PSSCH, and the number of symbols occupied by the PSCCH are determined, so that the symbol location of the SL-PRS in the slot may be determined with reference to the mapping tables shown in Table 1 to Table 3.

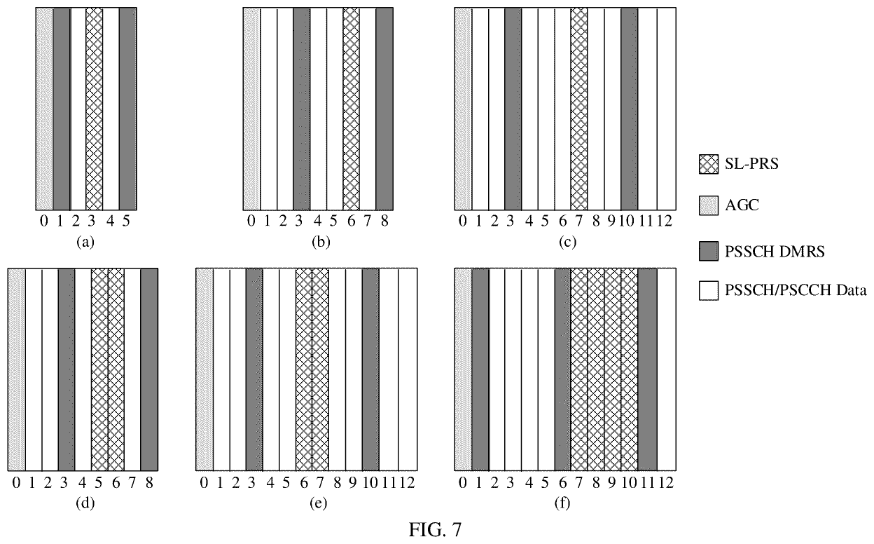

For example, assuming that the number of symbols for the SL-PRS is 1, through query from Table 1, in response to the total number of symbols being 6, the number of symbols occupied by the PSCCH is 2, and the number of symbols for the DMRS in the PSSCH is 2, the symbol location of the SL-PRS is “3”. In this case, for a diagram of the symbol location of the SL-PRS in the slot, refer to (a) in FIG. 7.

For another example, assuming that the number of symbols for the SL-PRS is 1, through query from Table 1 that, in response to the total number of symbols being 9, the number of symbols occupied by the PSCCH is 2, and the number of symbols for the DMRS in the PSSCH is 2, the symbol location of the SL-PRS is “6”. In this case, for a diagram of the symbol location of the SL-PRS in the slot, refer to (b) in FIG. 7.

For another example, assuming that the number of symbols for the SL-PRS is 1, through query from Table 1 that, in response to the total number of symbols being 13, the number of symbols occupied by the PSCCH is 2, and the number of symbols for the DMRS in the PSSCH is 2, the symbol location of the SL-PRS is “7”. In this case, for a diagram of the symbol location of the SL-PRS in the slot, refer to (c) in FIG. 7.

For another example, assuming that the number of symbols for the SL-PRS is 2, through query from Table 2 that, in response to the total number of symbols being 9, the number of symbols occupied by the PSCCH is 2, and the number of symbols for the DMRS in the PSSCH is 2, the symbol locations of the SL-PRS are “5” and “6”. In this case, for a diagram of the symbol locations of the SL-PRS in the slot, refer to (d) in FIG. 7.

For another example, assuming that the number of symbols for the SL-PRS is 2, through query from Table 2 that, in response to the total number of symbols being 13, the number of symbols occupied by the PSCCH is 2, and the number of symbols for the DMRS in the PSSCH is 2, the symbol locations of the SL-PRS are “6” and “7”. In this case, for a diagram of the symbol locations of the SL-PRS in the slot, refer to (e) in FIG. 7.

For another example, assuming that the number of symbols for the SL-PRS is 4, through query from Table 3 that, in response to the total number of symbols being 13, the number of symbols occupied by the PSCCH is 2, and the number of symbols for the DMRS in the PSSCH is 3, the symbol locations of the SL-PRS are “7”, “8”, “9”, and “10)”. In this case, for a diagram of the symbol locations of the SL-PRS in the slot, refer to (f) in FIG. 7.

In FIG. 7, (a) to (f) are merely examples, and do not constitute a limitation on embodiments described herein. In addition, Table 1 to Table 3 are merely examples of symbol locations of the SL-PRS in a slot. In actual application, there may be another case for a symbol location of the SL-PRS in a mapping table. This is not limited in at least one embodiment.

In addition, Table 1 to Table 3 only list the mapping tables for the symbol locations of the SL-PRS in response to the number of symbols being 1, 2, and 4. In response to a device indicating a value of more symbols, a mapping table for symbol locations of the SL-PRS for more symbols may also be included.

For example, in at least one embodiment, the mapping table for the symbol location of the SL-PRS may be generated based on the symbol location of the DMRS in the PSSCH according to one or more of the following rules:

Rule 1: The symbol location of the SL-PRS is in the middle of symbol locations of two adjacent DMRSs, and in a case in which the symbol location of the SL-PRS cannot be in the middle of symbol locations of two adjacent DMRSs, refer to Rule 3.

Rule 2: The symbol location of the SL-PRS is close to a symbol location of a last DMRS.

Rule 3: The symbol location of the SL-PRS is close to a symbol location of a DMRS on the right.

According to Rule 1, in response to the number of symbols for the SL-PRS being greater than 1, symbol locations of multiple SL-PRSs are not on two sides of a position of a DMRS in the PSSCH, which otherwise affects channel assessment performance of the DMRS. Because the location of the symbol occupied by the PSCCH is usually at the front end of a slot, Rule 2 can help, the symbol location of the SL-PRS be far away from the location of the symbol occupied by the PSCCH. In addition to having the effect of Rule 2, Rule 3 can also help a mapping table maker determine a unique fixed value as the symbol location of the SL-PRS to complete a procedure of determining a symbol location of the SL-PRS.

The foregoing Rule 1 to Rule 3 are merely specific mapping table generation rules for ease of understanding Table 1 to Table 3 and more mapping tables that may be subsequently formulated. In at least one embodiment, a mapping table of the symbol location of the SL-PRS may be generated according to another rule, or more or fewer rules. This rule is not limited in at least one embodiment.

In response to the symbol location of the first SL-PRS being determined through the mapping table of the symbol location of the SL-PRS, the mapping table of the symbol location of the SL-PRS in compliance with the symbol number of the first SL-PRS may be found from mapping tables of symbol locations of the SL-PRS for multiple symbol numbers, and the position of the first SL-PRS is determined based on a mapping relationship between the symbol location of the first SL-PRS and the total number of symbols for the slot in which the first SL-PRS is located, the number of symbols for the DMRS in the PSSCH, and the number of symbols occupied by the PSCCH in the mapping table. The number of symbols for the first SL-PRS may be obtained based on the configuration information of the SL-PRS.

In at least one embodiment, for different numbers of symbols, the mapping table of the symbol location of the SL-PRS may be pre-configured in the first device and the second device, or may be formulated in a protocol of communication between the first device and the second device. This is not limited in at least one embodiment.

The rule for formulating the start subcarrier location of the start symbol for the SL-PRS includes: The start subcarrier location of the start symbol for the SL-PRS is determined based on a value obtained by performing a modulo operation on a comb size of the SL-PRS based on the CRC. For a specific rule for determining the start subcarrier location, refer to related content in the foregoing Formula 2. Details are not described herein again.

From Manner 3 that, for the time-frequency rule of the SL-PRS, both devices may agree on, in advance, the number of symbols, the comb size, the pre-stored mapping table for the symbol location of the SL-PRS, and the preset rule for determining the start subcarrier location of the start symbol for the SL-PRS, so that the sender device and the receiver device can respectively send and receive the SL-PRS based on a same time-frequency mapping manner. In addition, compared with Manner 1, there is no need to notify the start symbol location and the start subcarrier location of the SL-PRS in advance before the SL-PRS is sent, thereby reducing signaling overheads.

In Manner 3, an interaction procedure between the sender device and the receiver device may include S201, S204, and S205 in the interaction procedure shown in FIG. 4. Details are not described herein again.

To implement the functions in the foregoing embodiments, the network device and the terminal device include corresponding hardware structures and/or software modules for performing the functions. A person skilled in the art should be readily aware that, with reference to the units and method steps in the examples described in embodiments herein, at least one embodiment can be implemented by hardware or a combination of hardware and computer software. Whether a function is performed by hardware or hardware driven by computer software depends on a particular application scenario and a design constraint condition of the technical solutions.

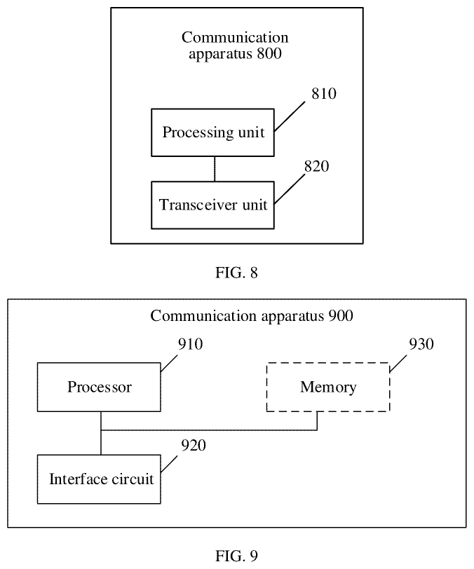

FIG. 8 and FIG. 9 are diagrams of structures of communication apparatuses according to at least one embodiment. These communication apparatuses may be configured to implement functions of the terminal device or the network device in the foregoing method embodiments, and therefore can also achieve beneficial effects of the foregoing method embodiments. In at least one embodiment, the communication apparatus may be the terminal device 1 or the terminal device 2 shown in (a), (b), and (c) in FIG. 1, or may be the network device shown in (a) and (b) in FIG. 1, or may be a module (for example, a chip) used in the terminal device or the network device.

As shown in FIG. 8, a communication apparatus 800 includes a processing unit 810 and a transceiver unit 820. The communication apparatus 800 is configured to implement the functions of the first device, the second device, or the base station in the method embodiments shown in FIG. 2 or FIG. 4.

In response to the communication apparatus 800 being configured to implement a function of the first device in the method embodiments shown in FIG. 2, the transceiver unit 820) is configured to: receive or send information involved in a process of establishing a communication connection to a second device, and send a first SL-PRS, first data, and the like to the second device based on a first time-frequency mapping manner. The processing unit 810 is configured to: determine the first time-frequency mapping manner, and determine a time-frequency position of an SL-PRS based on the first time-frequency mapping manner.

In response to the communication apparatus 800 being configured to implement a function of the second device in the method embodiments shown in FIG. 2, the transceiver unit 820 is configured to: receive or send information involved in a process of establishing a communication connection to a first device, and receive, based on a first time-frequency mapping manner, a first SL-PRS, first data, and the like sent by the first device. The processing unit 810 is configured to: determine the first time-frequency mapping manner, and determine a time-frequency position of an SL-PRS based on the first time-frequency mapping manner.

For more detailed descriptions about the processing unit 810 and the transceiver unit 820, directly refer to related descriptions in the method embodiments shown in FIG. 2. Details are not described herein again.

As shown in FIG. 9, a communication apparatus 900 includes a processor 910 and an interface circuit 920. The processor 910 and the interface circuit 920 are coupled to each other. The interface circuit 920 may be a transceiver or an input/output interface. Optionally, the communication apparatus 900 may further include a memory 930, configured to store instructions executed by the processor 910, store input data needed by the processor 910 to run the instructions, or store data generated after the processor 910 runs the instructions.

In response to the communication apparatus 900 being configured to implement the method shown in FIG. 2, the processor 910 is configured to implement a function of the processing unit 810), and the interface circuit 920 is configured to implement a function of the transceiver unit 820.

In response to the communication apparatus being a chip used in a terminal, the chip of the terminal implements a function of the terminal in the foregoing method embodiments. The chip of the terminal receives information from another module (for example, a radio frequency module or an antenna) of the terminal, where the information is sent by a base station to the terminal. Alternatively, the chip of the terminal sends information to another module (for example, a radio frequency module or an antenna) of the terminal, where the information is sent by the terminal to a base station.

In response to the communication apparatus being a module used in a base station, the module of the base station implements a function of the base station in the foregoing method embodiments. The module of the base station receives information from another module (for example, a radio frequency module or an antenna) of the base station, where the information is sent by a terminal to the base station. Alternatively, the module of the base station sends information to another module (for example, a radio frequency module or an antenna) of the base station, where the information is sent by the base station to a terminal. The module of the base station herein may be a baseband chip of the base station, or may be a DU or another module. The DU herein may be a DU in an open radio access network (open radio access network, O-RAN) architecture.

The processor in at least one embodiment may be a central processing unit (Central Processing Unit, CPU), or may be another general-purpose processor, a digital signal processor (Digital Signal Processor, DSP), an application-specific integrated circuit (Application-Specific Integrated Circuits, ASIC), a field programmable gate array (Field Programmable Gate Array, FPGA) or another programmable logic device, a transistor logic device, a hardware component, or any combination thereof. The general-purpose processor may be a microprocessor or any regular processor.

The method steps in at least one embodiment may be implemented by hardware, or may be implemented by executing software instructions by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or a storage medium in any other form well-known in the art. For example, a storage medium is coupled to the processor, so that the processor can read information from the storage medium and write information into the storage medium. Certainly, the storage medium may alternatively be a component of the processor. The processor and the storage medium may be located in an ASIC. In addition, the ASIC may be located in a base station or a terminal. Certainly, the processor and the storage medium may alternatively exist in the base station or the terminal as discrete components.

All or some of the foregoing embodiments may be implemented by using software, hardware, firmware, or any combination thereof. In response to software being used for implementation, all or some of embodiments may be implemented in a form of a computer program product. The computer program product includes one or more computer programs or instructions. In response to the computer programs or the instructions being loaded and executed on a computer, all or some of the procedures or functions according to at least one embodiment is performed. The computer may be a general-purpose computer, a dedicated computer, a computer network, a network device, user equipment, or another programmable apparatus. The computer programs or the instructions may be stored in a computer-readable storage medium, or may be transmitted from a computer-readable storage medium to another computer-readable storage medium. For example, the computer programs or the instructions may be transmitted from a website, computer, server, or data center to another website, computer, server, or data center in a wired or wireless manner. The computer-readable storage medium may be any usable medium accessible by the computer, or a data storage device, for example, a server or a data center, integrating one or more usable media. The usable medium may be a magnetic medium, for example, a floppy disk, a hard disk, or a magnetic tape: or may be an optical medium, for example, a digital video disc: or may be a semiconductor medium, for example, a solid-state drive. The computer-readable storage medium may be a volatile or non-volatile storage medium, or may include two types of storage media: a volatile storage medium and a non-volatile storage medium.

In at least one embodiment, unless otherwise specified or logically conflicted, terms and/or descriptions in different embodiments are consistent and may be mutually referenced, and technical features in different embodiments may be combined based on an internal logical relationship thereof, to form a new embodiment.

Depending on whether optional is used herein: In at least one embodiment, “at least one” means one or more, and “a plurality of” means two or more. “And/or” describes an association relationship between associated objects and indicates that three relationships may exist. For example, A and/or B may indicate the following cases: Only A exists, both A and B exist, and only B exists, where A and B may be singular or plural. In the text descriptions of embodiments described herein, the character “/” generally indicates an “or” relationship between the associated objects. In a formula, the character “/” indicates a “division” relationship between the associated objects. “Including at least one of A, B, and C” may indicate: including A; including B; including C; including A and B; including A and C; including B and C; and including A, B, and C.

Various numbers in at least one embodiment are merely used for distinguishing for ease of description, and are not used to limit the scope of embodiments described herein. Sequence numbers of the foregoing processes do not mean an execution sequence, and the execution sequence of the processes should be determined based on functions and internal logic of the processes.

1. A positioning reference signal configuration method, wherein the method comprises:
sending a first sidelink positioning reference signal (SL-PRS) and first data in a same slot based on a first time-frequency mapping manner, wherein the first time-frequency mapping manner describes a time-frequency position of the first SL-PRS relative to a first demodulation reference signal demodulation reference signal (DMRS) in the first data in the same slot, and the first DMRS is a reference signal in a physical sidelink shared channel (PSSCH).

2. The method according to claim 1, wherein the first time-frequency mapping manner is further determined according to a rule for determining a symbol location of the first SL-PRS, wherein
the rule for determining the symbol location includes:
in a same slot, M symbols for the first SL-PRS are at M symbol locations including and just before a last symbol in the PSSCH, wherein the M symbol locations do not include a symbol location of the first DMRS in the PSSCH, and M is a number of symbols for the first SL-PRS.

3. The method according to claim 1, wherein the first SL-PRS and the first data are sent based on configuration information of the first SL-PRS, and the configuration information includes a number of symbols and a comb size; and the first time-frequency mapping manner is determined based on the configuration information, wherein
a number of symbols for the first SL-PRS in one slot is a number of symbols in the configuration information, and a comb size of the first SL-PRS in frequency domain is the comb size in the configuration information.

4. The method according to claim 3, wherein the configuration information further includes: an initial symbol location and an initial subcarrier location of a second SL-PRS, wherein the initial symbol location is a start symbol location of the second SL-PRS in response to the second SL-PRS being sent, the initial subcarrier location is a start subcarrier location of the second SL-PRS, and a slot in which the second SL-PRS is located does not comprise data.

5. The method according to claim 4, wherein the first time-frequency mapping manner is further determined based on a first start symbol location and a first start subcarrier location, the first start symbol location is different from the initial symbol location, and the first start subcarrier location is different from the initial subcarrier location; and
before sending the first SL-PRS and the first data in the same slot, the method further comprises:
sending the first start symbol location and the first start subcarrier location, wherein a start symbol location of the first SL-PRS is the first start symbol location, and a start subcarrier location of the first SL-PRS is the first start subcarrier location.

6. A positioning reference signal configuration method, wherein the method comprises:
receiving a first sidelink positioning reference signal (SL-PRS) and first data in a same slot based on a first time-frequency mapping manner, wherein the first time-frequency mapping manner describes a time-frequency position of the first SL-PRS relative to a first demodulation reference signal (DMRS) in the first data in the same slot, and the first DMRS is a reference signal in a physical sidelink shared channel (PSSCH).

7. The method according to claim 6, wherein the first time-frequency mapping manner is further determined according to a rule for determining a symbol location of the first SL-PRS, wherein
the rule for determining the symbol location includes:
in the same slot, M symbols for the first SL-PRS are at M symbol locations including and just before a last symbol in the PSSCH, wherein the M symbol locations do not include a symbol location of the first DMRS in the PSSCH, and M is a number of symbols for the first SL-PRS.

8. The method according to claim 6, wherein the first SL-PRS and the first data are received based on configuration information of the first SL-PRS, and the configuration information includes a number of symbols and a comb size; and the first time-frequency mapping manner is determined based on the configuration information, wherein
a number of symbols for the first SL-PRS in one slot is a number of symbols in the configuration information, and a comb size of the first SL-PRS in frequency domain is the comb size in the configuration information.

9. The method according to claim 8, wherein the configuration information further includes an initial symbol location and an initial subcarrier location of a second SL-PRS, wherein the initial symbol location is a start symbol location of the second SL-PRS in response to the second SL-PRS being received, the initial subcarrier location is a start subcarrier location of the second SL-PRS, and a slot in which the second SL-PRS is located does not comprise data.

10. The method according to claim 9, wherein the first time-frequency mapping manner is further determined based on a first start symbol location and a first start subcarrier location, wherein the first start symbol location is different from the initial symbol location, and the first start subcarrier location is different from the initial subcarrier location: and
before receiving the first SL-PRS and the first data in the same slot, the method further comprises:
receiving the first start symbol location and the first start subcarrier location, wherein a start symbol location of the first SL-PRS is the first start symbol location, and a start subcarrier location of the first SL-PRS is the first start subcarrier location.

11. The method according to claim 6, wherein the method further comprises:
determining, based on the first SL-PRS, location information of a device that sends the first SL-PRS, wherein the location information includes one or more of the following: a distance, an angle, or an altitude.

12. A communication apparatus comprising: at least one processor coupled to at least one memory storing instructions and configured to execute the instructions to cause the communication apparatus to perform:
sending or receiving a first sidelink positioning reference signal (SL-PRS) and first data in a same slot based on a first time-frequency mapping manner, wherein the first time-frequency mapping manner describes a time-frequency position of the first SL-PRS relative to a first demodulation reference signal demodulation reference signal (DMRS) in the first data in the same slot, and the first DMRS is a reference signal in a physical sidelink shared channel (PSSCH).

13. The communication apparatus according to claim 12, wherein the first time-frequency mapping manner is further determined according to a rule for determining a symbol location of the first SL-PRS, wherein
the rule for determining the symbol location includes:
in a same slot, M symbols for the first SL-PRS are at M symbol locations comprising including and just before a last symbol in the PSSCH, wherein the M symbol locations do not include a symbol location of the first DMRS in the PSSCH, and M is a number of symbols for the first SL-PRS.

14. The communication apparatus according to claim 12, wherein the first SL-PRS and the first data are sent based on configuration information of the first SL-PRS, and the configuration information includes a number of symbols and a comb size; and the first time-frequency mapping manner is determined based on the configuration information, wherein
a number of symbols for the first SL-PRS in one slot is a number of symbols in the configuration information, and a comb size of the first SL-PRS in frequency domain is the comb size in the configuration information.

15. The communication apparatus according to claim 14, wherein the configuration information further includes: an initial symbol location and an initial subcarrier location of a second SL-PRS, wherein the initial symbol location is a start symbol location of a second SL-PRS in response to the second SL-PRS being sent, the initial subcarrier location is a start subcarrier location of the second SL-PRS, and a slot in which the second SL-PRS is located does not include data.

16. The communication apparatus according to claim 15, wherein the first time-frequency mapping manner is further determined based on a first start symbol location and a first start subcarrier location, the first start symbol location is different from the initial symbol location, and the first start subcarrier location is different from the initial subcarrier location; and
before sending the first SL-PRS and the first data in the same slot, the communication apparatus is further caused to perform:
sending the first start symbol location and the first start subcarrier location, wherein a start symbol location of the first SL-PRS is the first start symbol location, and a start subcarrier location of the first SL-PRS is the first start subcarrier location.

17. The communication apparatus according to claim 12, the communication apparatus is further caused to perform:
determining, based on the first SL-PRS, location information of a device that sends the first SL-PRS, wherein the location information includes one or more of the following: a distance, an angle, or an altitude.
